(19) United States
(12) Patent Application Publication
(10) Pub. No.: US 2025/0258732 A1
(43) Pub. Date: Aug. 14, 2025

(54) INFORMATION PROVISION SYSTEM AND CONTROL METHOD THEREOF

(71) Applicant: CANON KABUSHIKI KAISHA, Tokyo (JP)

(72) Inventor: TAKUMA HIROSE, Kanagawa (JP)

(21) Appl. No.: 19/048,810

(22) Filed: Feb. 7, 2025

(30) Foreign Application Priority Data
Feb. 14, 2024 (JP) 2024-020510

(51) Int. Cl. G06F 11/07

(52) U.S. Cl. CPC G06F 11/0733; G06F 11/0769; G06F 11/0793

(57) ABSTRACT

An information provision system manages error information indicating errors occurring in an image processing device collected from the image processing device, provides a screen in which information about unhandled errors of the designated image processing device is listed, and receives feedback related to handling of maintenance performed on the image processing device. The error information includes device information for identifying an image processing device, an error code corresponding to a failure of the image processing device, a date and time of occurrence of an error, and handling information indicating whether or not the handling of the maintenance has been performed. The processor updates handling information for an error handled by the maintenance for which the feedback has been received from an unhandled state to a handled state and collectively updates handling information of error codes identical to an error code of the error from the unhandled state to the handled state with respect to the error information of the same image processing device.

### BACKGROUND OF THE INVENTION

### Field of the Invention

The present invention relates to an information provision system for providing error information and a control method thereof.

### Description of the Related Art

A management system for managing device information and operation information of image processing devices (hereinafter also referred to as devices) such as printers, copiers, and multifunction printers has been constructed. In the management system, when a failure occurs in a device, the server receives a notification of the failure transmitted from the device and an occurrence situation of the failure (a failure time, a failed device, and a type of error that has occurred) can be managed. Moreover, as similar technology, a mechanism for diagnosing failures by analyzing the content of failures has also been proposed. Japanese Unexamined Patent Publication No. 2020-199704 discloses a system that receives a failure diagnosis result transmitted from the device and displays the replacement guidance for a failed part based on a record of past replacement work. Japanese Unexamined Patent Publication No. 2008-211662 discloses a system that presents accurate maintenance information suitable for the error type and status of the failed device and does not depend on the skill of a service member by searching a database in which a countermeasure method is recorded for each error type and status of the failed device.

Error information generated by the device is automatically acquired and displayed on an error information list screen. However, because multiplex transmission of errors is allowed as a measure to prevent the omission of error transmission due to a device restart when an error occurs or the omission of reception such as data loss due to a user's infrastructure environment, duplicate errors with the same error code may be displayed. In this case, even if the user performs an action for an image processing device in accordance with a flow and recovers from the error, because the same error that has occurred in a plurality of cases is not handled, it takes time and effort to change the states thereof to the handled state one by one, which may lead to an increase in work time. Moreover, if the error information list screen becomes busy, other error information may be overlooked or an action may be omitted.

### SUMMARY OF THE INVENTION

The present invention facilitates the handling of a plurality of errors with the same error code.

According to the present invention, there is provided an information provision system including: a memory storing instructions; and a processor executing the instructions causing the information provision system to: manage error information indicating errors occurring in an image processing device collected from the image processing device; provide a screen in which information about unhandled errors of the designated image processing device is listed; and receive feedback related to handling of maintenance performed on the image processing device, wherein the error information includes device information for identifying an image processing device, an error code corresponding to a failure of the image processing device, a date and time of occurrence of an error, and handling information indicating whether or not the handling of the maintenance has been performed, and wherein the processor updates handling information for an error handled by the maintenance for which the feedback has been received from an unhandled state to a handled state and collectively updates handling information of error codes identical to an error code of the error from the unhandled state to the handled state with respect to the error information of the same image processing device.

Further features of the present invention will become apparent from the following description of exemplary embodiments with reference to the attached drawings.

### BRIEF DESCRIPTION OF THE DRAWINGS

FIG. 1 is a diagram showing an overall configuration of the information provision system.

FIGS. 2A and 2B are diagrams showing a hardware configuration of a repair part notification server and a printer.

FIG. 3 is a diagram showing a software configuration of the information provision system.

FIG. 4 is a flowchart showing a recommended action estimation process.

FIG. 5 is a flowchart showing the recommended action estimation process.

FIGS. 6A and 6B are flowcharts showing an estimation process and an action estimation process on a repair part.

FIG. 7 is a flowchart showing an action priority adjustment process.

FIG. 8 is an explanatory flowchart of a process of changing a handling state of an error history.

FIG. 9 is a diagram showing an example of an error information list screen.

FIG. 10 is a diagram showing an example of a repair procedure display screen.

FIG. 11 is a diagram showing an example of the repair procedure display screen.

FIG. 12 is a diagram showing a software configuration of an information provision system in Example 3.

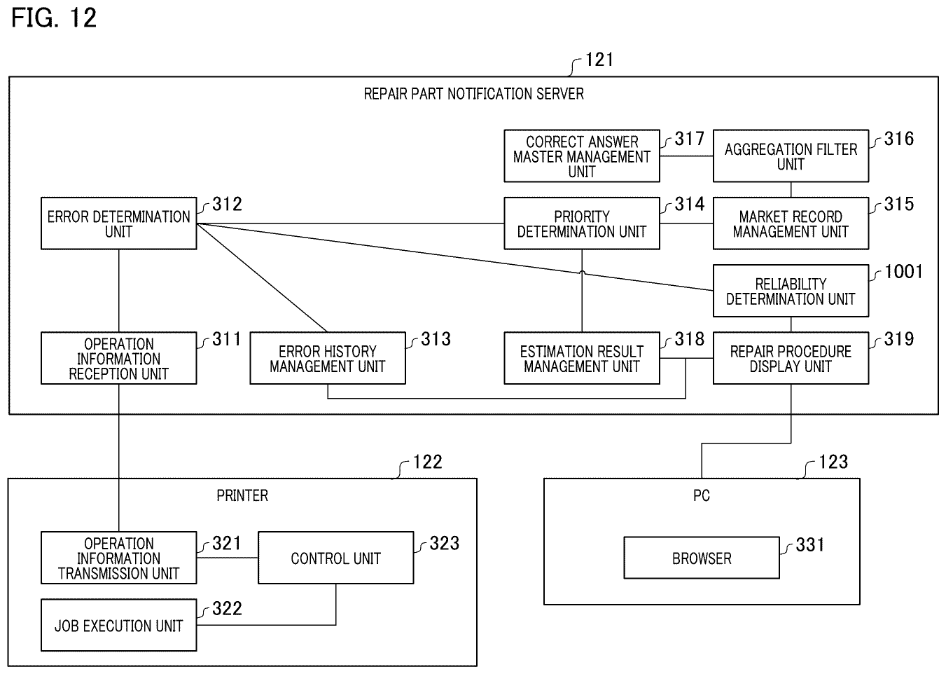

FIG. 13 is a diagram showing an example of a repair procedure display screen in Example 3.

### DESCRIPTION OF THE EMBODIMENTS

### Example 1

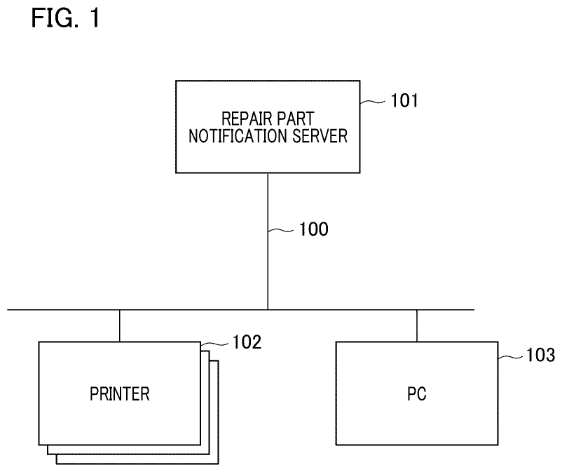

FIG. 1 is a diagram showing an overall configuration of the information provision system. The information provision system is a system that collects device operation information including error information and the like from image processing devices via a network and provides error information, recommended repair parts, and action information to an engineer or the like in charge of repairs. The information provision system includes a repair part notification server 101 that provides a repair part notification service, a printer 102 that is an image processing device serving as an error detection target, and a PC 103 that is a terminal that receives information provided from the repair part notification service. These constituent elements are communicatively connected to each other via a network 100. It is only necessary for the network 100 to be configured so that data transmission and reception are enabled and any communication method may be used. For example, the network 100 is composed of any of a LAN, a WAN, a cellular network such as LTE or 5G, a wireless network, a telephone line, a dedicated digital line, or a combination thereof.

The repair part notification server 101 provides error information about an error occurring in an image processing device such as the printer 102 and data for outputting information about a recommended action for eliminating the error to the PC 103 used by the engineer. The repair part notification server 101 is located on, for example, on the Internet. First, the repair part notification server 101 receives error information indicating an error that has occurred in the printer 102 or the like from the image processing device, and estimates one or more repair part information items for eliminating the error. Furthermore, the repair part notification server 101 manages a record of an action performed on the market as a market record with respect to a previous similar error and decides a priority of the action on the basis of the market record. Also, the repair part notification server 101 provides error information, repair part information, processing information for eliminating errors, and the like to the PC 103 used by a customer engineer in charge of repairing the printer 102 or the like. Moreover, the repair part notification server 101 collects feedback information from the customer engineer who has performed an action for eliminating the error.

The repair part notification server 101 of the present example allows multiplex transmission of errors from the printer 102 as a measure to prevent the omission of error transmission due to a device restart when an error occurs or the omission of reception such as data loss due to a user's infrastructure environment. Therefore, error information having the same error code may be duplicated in the error history managed by the repair part notification server 101. Although an example in which an action for an error is estimated on the basis of a market record will be described in the present embodiment, the present invention is not limited thereto and the action for the error may be estimated, for example, using AI. The AI collects information about work performed by the service member and replacement parts, operates a trained model in which machine learning has been performed on the basis of the information, and estimates an action.

The repair part notification server 101 may be implemented by a virtual machine (a cloud service) using resources provided by a data center including an information processing device, or a combination thereof in addition to one or more information processing devices. Moreover, the information provision system can be implemented as a web-based application and can be used via a web browser in the PC 103. Moreover, the repair part notification server 101 may be implemented to be separated into a data collection server that collects data such as error information from the printer 102 and a repair part notification server that estimates the repair part based on the data collected by the data collection server and presents a recommended action. Moreover, the repair part notification server 101 may be an on-premises system configuration using a physical server.

The printer 102 is an example of an image processing device managed by an information provision system. There may be a plurality of printers 102 managed by the information provision system. The image processing device is not limited to a printer, and it is only necessary for the image processing device to have any one of a printing function, a copy function, a scanning function, a data network transmission function, or a fax function like an MFP having a printing function, a fax function, a copying function, and a scanner function, and the like, a scanner device, a 3D printer, or the like. The printer 102 transmits error information including device information to the repair part notification server 101 when the occurrence of an error related to its device and an attached optional device is detected.

The personal computer (PC) 103 is an example of an information processing device. A predetermined OS is installed on the PC 103. Moreover, a browser 331 to be described below is installed in the PC 103. The PC 103 displays the screen provided by the repair part notification server 101 via the browser 331. For example, the PC 103 transmits a request to acquire error information (alert information) of the printer 102 to the repair part notification server 101 via the browser 331. Also, the PC 103 receives error information from the repair part notification server 101 as a response and displays the received error information with a graphical user interface (GUI). Also, the PC 103 is used, for example, by a company that dispatches a customer engineer (a service member) who is undertaking maintenance of the printer 102 or the like. The engineer can perform a remote control manipulation on the printer 102 via a screen provided by the remote control server 104 displayed on the browser 331 of the PC 103. In addition, the PC 103 may be any terminal capable of displaying a screen provided from the information provision system or may be a tablet, a smartphone, or the like.

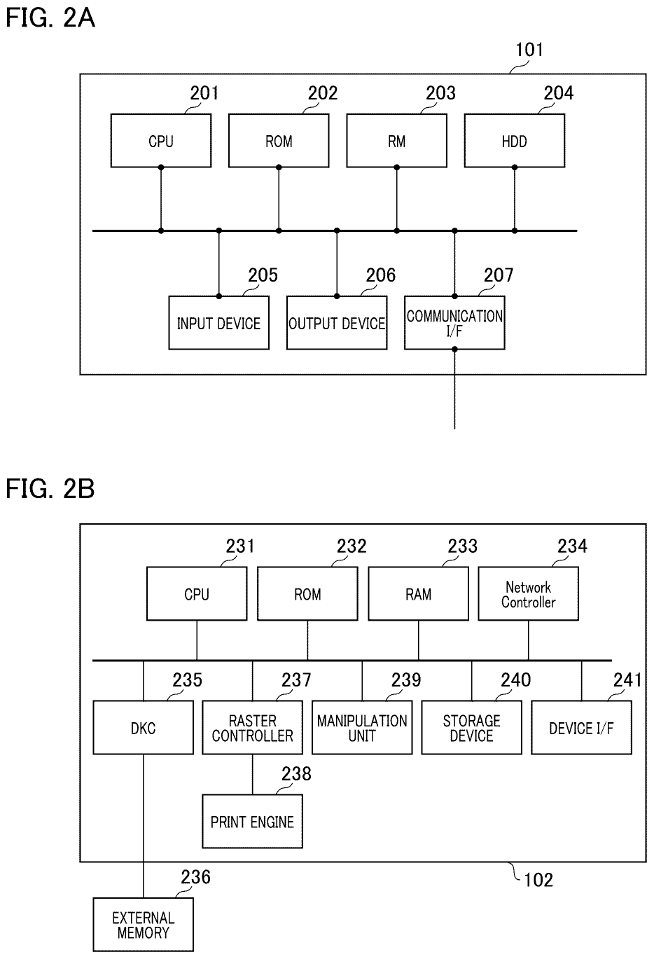

FIG. 2A is a diagram showing a hardware configuration of the repair part notification server 101. In addition, a hardware configuration of the PC 103 is also similar to that of the repair part notification server 101. The repair part notification server 101 includes a central processing unit (CPU) 201, a read-only memory (ROM) 202, a random-access memory (RAM) 203, a hard disk drive (HDD) 204, an input device 205, an output device 206, and a communication I/F 207. Constituent elements of the hardware are connected to a system bus.

The CPU 201 controls the entire repair part notification server 101. The CPU 201 reads a control program stored in the ROM 202 or the HDD 204 and executes various types of control processes. The ROM 202 is a memory for reading data only, and stores a basic control program of an information processing device such as, for example, a basic input output system (BIOS) or the like. The RAM 203 is a memory from/to which data can be read/written. The RAM 203 functions, for example, as a work area of the CPU 201. The HDD 204 stores various types of data and programs. Although an example in which the repair part notification server 101 includes the HDD 204 as a storage device will be described in the present embodiment, the present invention is not limited thereto, and another storage device such as, for example, an SSD, or a disk drive in which external media are loaded may be provided.

The input device 205 receives a manipulation from the user. For example, a keyboard, a pointing device, or the like is connected to the input device 205. The output device 206 performs a display process for the user. For example, a display such as a liquid crystal screen is connected to the output device 206. The communication I/F 207 is an interface for connecting to the network 100. The repair part notification server 101 communicates with external devices such as the printer 102 and the PC 103 via the communication I/F 207 and the network 100.

After the repair part notification server 101 starts, the CPU 201 executes the BIOS and loads the OS to be executable from the HDD 204 to the RAM 203. The CPU 201 loads various types of software modules to be described below to be executable from the HDD 204 to the RAM 203 at any time in accordance with the operation of the OS. The various types of software modules are executed and operated by the CPU 201 in cooperation with the above-described devices. Moreover, the communication I/F 207 is connected to the network 100 and is controlled by the CPU 201 in accordance with the operation of the OS to implement communication.

FIG. 2B is a diagram showing a hardware configuration of the printer 102. The printer 102 includes a CPU 231, a ROM 232, a RAM 233, a network controller 234, a DKC 235, a raster controller 237, a print engine 238, a manipulation unit 239, a storage device 240, and a device I/F. Among these constituent elements, a part from which the print engine 238 is excluded may be referred to as a controller that controls the control system of the printer. Constituent elements of the hardware are connected to the system bus.

The CPU 231 controls the entire printer 102 and generally controls access to various types of devices connected to the system bus. The CPU 231 reads a control program and the like stored in the ROM 232 or a control program and resource data (resource information) stored in an external memory 236 connected via the disk controller (the DKC 235) and executes various types of control processes.

The ROM 232 stores a program to be executed by the CPU 231. The RAM 233 functions as the main memory, work area, and the like of the CPU 231. The RAM 233 is configured so that a memory capacity can be expanded by an optional RAM connected to an expansion port (not shown). The storage device 240 is a storage means that functions as a large-capacity memory. The storage device 240 stores image data, various types of programs, and various types of setting information.

The network controller 234 is a communication controller, for example, a network interface card (NIC). The CPU 231 exchanges data with an external device on the network 100 via the network controller 234. The DKC 235 controls access to a storage device such as the external memory 236. The external memory 236 records programs and resource data.

The manipulation unit 239 displays a screen and receives the user's manipulation instructions via the screen. The manipulation unit 239 is, for example, a touch panel. On the touch panel, settings such as operation modes of the printer 102 and an operation status of the printer 102 are displayed. By associating input coordinates and display coordinates in the touch panel, it is possible to construct a GUI as if the user can directly manipulate the screen displayed on the touch panel. Moreover, a button for performing a manipulation for setting the operation mode of the printer 102 and the like or designating the content data to be printed may be arranged on the manipulation unit 239.

The raster controller 237 is, for example, a controller that converts print data described in a PDL language into image data. The print engine 238 utilizes the known printing technology to form an image on a recording medium (e.g., paper) on the basis of image data input from the raster controller 237. The printing method performed by the print engine 238 is, for example, an electrophotographic method (a laser beam method), an inkjet method, a sublimation (thermal transfer) method, or the like, and any method may be used. A device I/F 241 is a connection I/F with an external device that can be connected by a USB or the like.

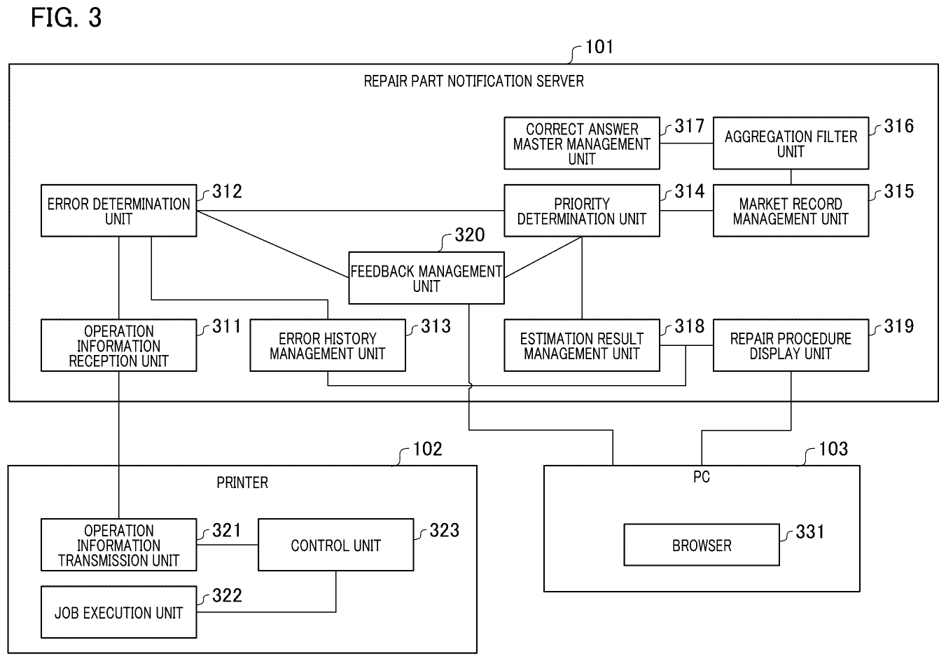

FIG. 3 is a diagram showing a software configuration of an information provision system. The software configuration is implemented by the CPU executing a program stored in the memory of each device. In addition, the schema and data of the table to be described below are only examples, and the schema of the table, the format of various types of data, and the like are not limited thereto.

The repair part notification server 101 includes an operation information reception unit 311, an error determination unit 312, an error history management unit 313, and a priority determination unit 314. Furthermore, the repair part notification server 101 includes a market record management unit 315, an aggregation filter unit 316, a correct answer master management unit 317, an estimation result management unit 318, a repair procedure display unit 319, and a feedback management unit 320.

The operation information reception unit 311 receives operation information from the printer 102. The information received by the operation information reception unit 311 includes information indicating operation states of the printer 102, such as information for identifying a device, error information (event information) based on the occurrence of an error, the number of printed pages in the printer 102, and the remaining amounts of consumable items. The information for identifying the device included in the operation information includes, for example, a device ID for uniquely identifying the device and a model number indicating a model of the device. The error information is, for example, an error code for recognizing a type of error. The error code is a unique string code assigned to each type of error. When the error information is included in the operation information, the operation information reception unit 311 transmits the operation information to the error determination unit 312.

When the error information is received from the operation information reception unit 311, the error determination unit 312 acquires an error history indicating error information that has occurred in the past at the printer that transmitted the error information from the error history management unit 313. Also, the error determination unit 312 estimates one or more parts that cause the error on the basis of the received error information, i.e., one or more repair parts for eliminating the error. Furthermore, the error determination unit 312 estimates a high or low failure possibility. The error determination unit 312 handles a repair part identified to eliminate the error and its failure possibility as an error determination result. The error determination unit 312 transmits an estimation result together with error information to the priority determination unit 314.

Table 1 is an example of a determination result output by the error determination unit 312.

TABLE 1

| Part number | Failure possibility |
|---|---|
| Part1-111 | high |
| Part1-112 | high |
| Part1-113 | high |
| Part1-114 | low |
| Part1-115 | low |

The determination result includes a part number for uniquely identifying a part that causes the error and a failure possibility for the part. The failure possibility is expressed, for example, as high or low. In addition, in a case where the error determination unit 312 cannot identify the repair part such as a case where it cannot identify an error on the basis of received error information (an error code), the determination result indicates that “the repair part cannot be identified.” Moreover, the error determination unit 312 saves the error information received from the printer 102 in the error history management unit 313 as an error history.

The error history management unit 313 saves and manages error information received from the error determination unit 312 as the error history. Table 2 is an example of the error history managed by the error history management unit 313.

TABLE 2

| | | | | | | | |
|---|---|---|---|---|---|---|---|
| | | Model | | Count | Occurrence | | |
| Error ID | Device ID | number | Error code | value | date and time | Handling | Flag |

| | | | | | | |
|---|---|---|---|---|---|---|
| Err-001 | DEV0000001 | Model-001 | E001-0001 | 5000 | 2022-10-01T12:35:50Z | Unhandled |
| Err-001 | DEV0000001 | Model-001 | E001-0001 | 5000 | 2022-10-01T12:34:56Z | Unhandled |
| Err-002 | DEV0000002 | Model-002 | E002-0002 | 1500 | 2022-09-03T00:00:00Z | Handled |
| Err-003 | DEV0000001 | Model-001 | E003-0001 | 2000 | 2022-09-01T00:12:34Z | Handled |

The error history includes an error ID for uniquely identifying an error, a device ID for uniquely identifying the printer in which the error has occurred, a model number indicating a model, an error code indicating a type of error that has occurred, a counter value that is the number of printed pages at the time of occurrence of the error, and a date and time of occurrence of the error. Furthermore, the error history includes handling information and a batch action flag indicating a handling state for the error.

In the handling information (handling state status), “unhandled” indicating that no handling has been performed is registered as an initial value. Also, when it is confirmed that the handling has been completed on the basis of feedback information, the handling state is changed to “handled” indicating that the action for the error has been completed and “handled” is registered. In the example shown in Table 2, error information shown in records in the first row and the second row is duplicate error information having the same error code. The batch action flag is information indicating that a process of changing the handling state of the error history has been performed in a batch. When the duplicate error information is changed from an unhandled state to a handled state, the batch action flag is set to error information other than the error information for which the error occurrence date and time is the latest within the duplicate error information.

The priority determination unit 314 estimates a priority of a procedure for the action (maintenance handling) to be performed to eliminate the error occurring in the printer 102. Specifically, when the priority determination unit 314 receives a determination result from the error determination unit 312, the priority determination unit 314 acquires a market record and feedback information. The priority determination unit 314 acquires a market record consistent with a model number and an error code of error information included in the determination result from the market record management unit 315 and feedback information corresponding to the determination result from the feedback management unit 320. The priority determination unit 314 ranks a repair procedure on the basis of the market record and feedback information. The priority determination unit 314 saves the ranked repair procedure in the estimation result management unit 318 as an estimation result.

The market record management unit 315 maintains and manages two types of aggregate results for all actions taken to eliminate errors that have occurred in the past. As one type of aggregation result, in the aggregation of the number of replacement parts (market replacement result), the number of replacement parts is aggregated according to each model number, error code, or part number. As the other type of aggregation result, in the aggregation of actions, the actions performed according to each model number or error code are aggregated. The market record management unit 315 collects record information including an action according to each model number, error code, or part number, and the like from the customer engineer who has performed the action to eliminate the error, aggregates the number of records for each part and each action, and maintains and manages an aggregation result.

Table 3 is an example of a market replacement record that is an aggregation of the number of replacement parts in the market record managed by the market record management unit 315.

TABLE 3

| Model | Error | Part | Number of |
|---|---|---|---|
| number | code | number | replacements |
| Model-001 | E001-001 | Part1-111 | 510 |
| Model-001 | E001-001 | Part2-222 | 218 |
| Model-001 | E001-001 | Part3-333 | 92 |
| Model-001 | E001-001 | Part4-444 | 40 |
| Model-001 | E001-001 | Part5-555 | 140 |
| Model-001 | E002-002 | Part5-555 | 2000 |

The market record related to the number of replacement parts includes a model number indicating a model, an error code indicating a type of error that has occurred, a part number of a part that has been replaced in response to the error, and the number of replacements that is the number of part replacement records.

The priority determination unit 314 decides a priority of the repair part on the basis of the aggregation result of the number of replacement parts and the determination result of the error determination unit 312. For example, the priority determination unit 314 sets the priority by ranking the repair parts that are likely to eliminate the error in order from the largest number of actions in the market record consistent with the repair part and the part number included in the determination result. Table 4 is an example of an estimation result of the repair part estimated by the priority determination unit 314.

TABLE 4

| Device ID | Error code | Part number | Priority |
|---|---|---|---|
| DEV0000001 | E001-0001 | Part1-111 | 51.0 |
| DEV0000001 | E001-0001 | Part2-222 | 21.8 |
| DEV0000001 | E001-0001 | Part3-333 | 9.2 |
| DEV0000001 | E001-0001 | Part4-444 | — |
| DEV0000001 | E001-0001 | Part5-555 | — |

The estimation result includes a device ID, an error code, a part number of a repair part for an error, a failure cause probability, and a priority indicating the order of a part to be repaired. An example of a method for calculating priorities of repair parts will be described below.

Table 5 is an example of a market action record that is an aggregation of actions of market records managed by the market record management unit 315.

TABLE 5

| Model | | | Replacement |
|---|---|---|---|
| number | Error code | Action | part |
| Model-001 | E001-001 | replace | part1-111 |
| Model-001 | E001-001 | adjust | |
| Model-001 | E001-001 | clean | |
| Model-001 | E001-001 | replace | part2-222 |
| Model-001 | E001-001 | adjust | |
| Model-001 | E002-002 | clean | |
| Model-001 | E002-002 | clean | |
| Model-001 | E002-002 | adjust | |
| Model-001 | E003-003 | replace | part3-333 |
| Model-002 | E001-001 | replace | part1-111 |
| Model-002 | E003-003 | clean | |

The market record related to the action includes a model number indicating a model, an error code indicating a type of error that has occurred, and an action performed for the error. Furthermore, when the action that has been performed was a replacement, the market record related to the action includes a part number indicating the replaced part.

The priority determination unit 314 decides the priority of the action for eliminating the error on the basis of the priority of the estimated repair part and the determination result of the error determination unit 312. Table 6 is an example of a result of estimating an action determined by the priority determination unit 314. Table 6 shows the priority of processing for an error having the model number Model-001 and the error code E001-001.

TABLE 6

| Model number | Error code | Action | Priority |
|---|---|---|---|
| Model-001 | E001-001 | replace | A |
| Model-001 | E001-001 | adjust | A |
| Model-001 | E001-001 | clean | B |

The action estimation result includes a device ID, an error code, an action for eliminating the error, and a priority of each action. For example, actions for eliminating the error include a part replacement (replace), an adjustment (adjust) such as the change of a setting value or the update of firmware, cleaning (clean), and the like.

The feedback management unit 320 aggregates feedback information about actions performed by the customer engineer for errors that have occurred in the past and holds and manages feedback information for each error. As the feedback information, the feedback management unit 320 acquires device information, error information, and information about a process of eliminating the error from the PC 103 or the like. Also, the feedback management unit 320 manages an action score for each combination of a model and an error ID. The feedback management unit 320 aggregates and holds scores of actions for errors for each model and reaggregates values of action scores in accordance with their content every time the feedback information is received. The feedback management unit 320 transmits an action score corresponding to an estimated error that is a determination result received from the error determination unit 312 to the priority determination unit 314. In the priority determination unit 314, a priority value of the estimation result of the action is adjusted by the action score. The priority determination unit 314 manages the estimation of the repair part and the estimation of the action as one estimation result.

The correct answer master management unit 317 manages a correct answer master that defines theoretically correct combinations of parts and actions. For example, in accordance with the definition of the correct answer master management unit 317, the aggregation filter unit 316 excludes combinations that are not defined to be theoretically correct from the combinations of repair parts and actions obtained from the aggregation result of the market record of the action (Table 5) and the estimation result of the action (Table 6).

The estimation result management unit 318 manages the priorities (Table 4) and the actions (Table 6) of the repair parts determined by the priority determination unit 314 in combination. Table 7 is an example of an estimation result managed by the estimation result management unit 318.

TABLE 7

| | | | | Failure cause | | | |
|---|---|---|---|---|---|---|---|
| Priority | Device ID | Error code | Part number | probability | Replace | Clean | Adjust |
| 1 | DEV0000001 | E001-001 | Part1-111 | 51 | A | — | A |
| 2 | DEV0000001 | E001-001 | Part2-222 | 21.8 | A | B | — |
| 3 | DEV0000001 | E001-001 | Part3-333 | 9.2 | — | B | A |
| 4 | DEV0000001 | E001-001 | Part5-555 | Low | — | — | — |
| | | | | possibility | | | |
| 5 | DEV0000001 | E001-001 | Part4-444 | Low | — | — | — |
| | | | | possibility | | | |

The estimation result managed by the estimation result management unit 318 includes a priority of the part, a device ID, an error code, a part number, a failure cause probability, and a priority of each action (replacement, cleaning, or adjustment).

The repair procedure display unit 319 provides a repair procedure display screen to the PC 103 viewed by the customer engineer via the browser 331. Specifically, when a repair procedure acquisition request including a device ID and an error ID is received from the browser 331 of the PC 103, the repair procedure display unit 319 acquires an error history consistent with the device ID and the error ID from the error history management unit 313. The repair procedure display unit 319 acquires an estimation result consistent with the device ID and the error code from the estimation result management unit 318. Also, the repair procedure display unit 319 generates a repair procedure display screen on the basis of the acquired error history and the estimation result and returns the generated repair procedure display screen to the browser 331 of the PC 103.

Furthermore, the repair procedure display unit 319 generates a feedback information input screen for inputting an execution result (feedback) after the customer engineer executes an action (maintenance handling) and provides the feedback information input screen to the browser 331. Error information including device information and an error code is displayed in advance on the feedback information input screen and the customer engineer inputs handling content of the action (maintenance handling) performed to eliminate the error. The repair procedure display unit 319 also functions as a reception means for receiving action feedback from the PC 103 and transmits the received feedback information to the feedback management unit 320. Moreover, the error history management unit 313 updates the handling state status, which is a status indicating the handling state of the error information being managed, from “unhandled” to “handled” on the basis of the feedback information.

Although an example in which the error determination unit 312 and the priority determination unit 314 perform estimation using a rule base based on received error information, an error history that has occurred in the past, and the like has been described in the present embodiment, the present invention is not limited thereto. For example, machine learning including deep learning may be used to estimate repair parts and actions.

The printer 102 includes an operation information transmission unit 321, a job execution unit 322, and a control unit 323. The operation information transmission unit 321 transmits operation information of the printer 102 including error information generated in the printer 102 collected by the control unit 323 to the repair part notification server 101. The job execution unit 322 executes a job input to the printer 102. For example, when a print job has been input, the job execution unit 322 executes a printing process on the basis of the print job. The control unit 323 collects an operation state of the printer 102 and transmits the collected operation state to the repair part notification server 101 via the operation information transmission unit 321 as the operation information. For example, the control unit 323 detects an error that has occurred in the printer 102, collects error information, and transmits the error information to the repair part notification server 101 via the operation information transmission unit 321.

The PC 103 has the browser 331. The PC 103 transmits a repair part information acquisition request of the printer 102 to the repair part notification server 101 via the browser 331, receives the repair part information from the repair part notification server 101, and displays the repair part information in a GUI as a response thereto. Moreover, the PC 103 receives a feedback information input screen for inputting feedback information from the repair part notification server 101 via the browser 331 and displays the feedback information input screen in the GUI. That is, the PC 103 displays a screen provided from the information provision system via the browser 331, which is a web browser.

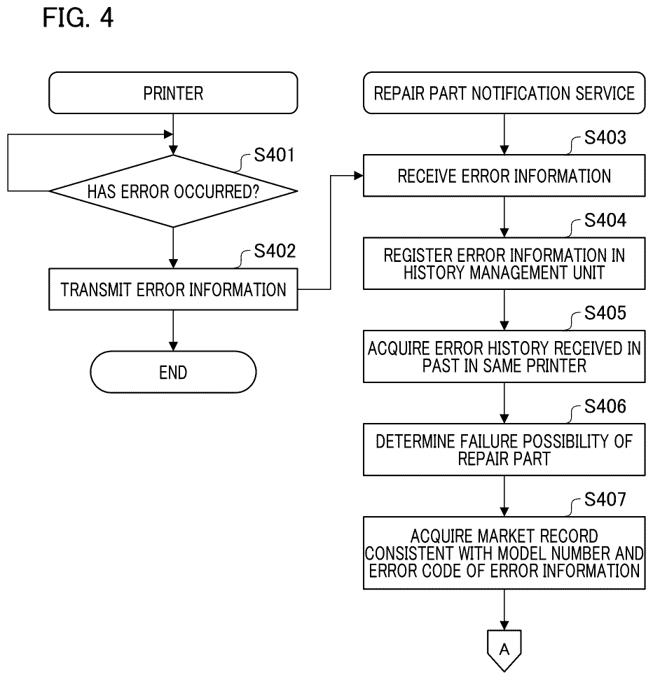

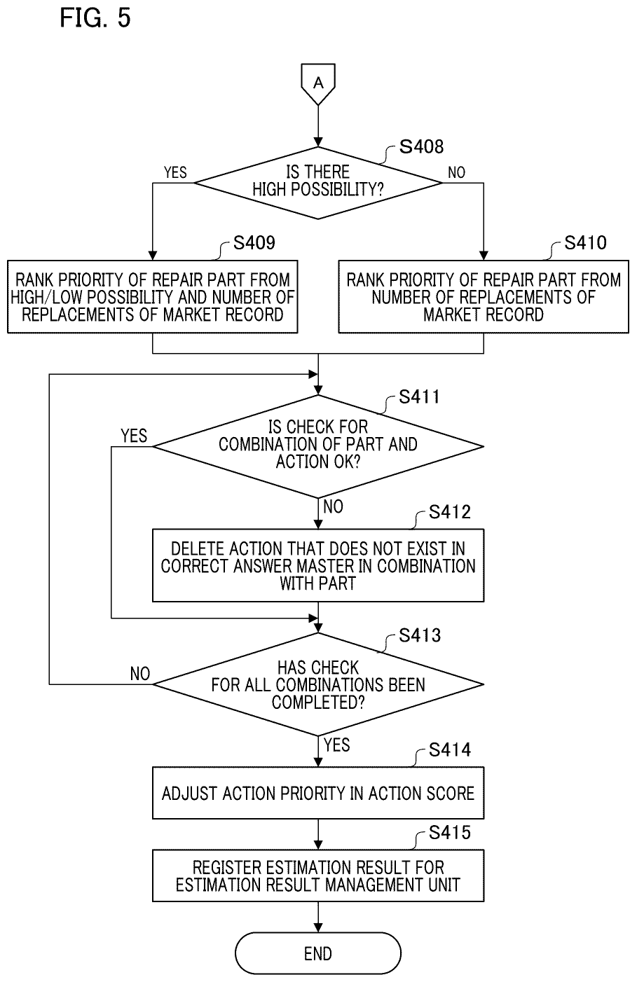

Next, a process for estimating an action for eliminating the error of the printer 102 (a recommended action estimation process) will be described. The result of the recommended action estimation process is saved in the estimation result management unit 318 and provided to the customer engineer or the like via the browser 331 when a display request is received from the PC 103. FIGS. 4 and 5 are flowcharts showing the recommended action estimation process. In the recommended action estimation process, the estimation result shown in Table 7 is finally calculated and saved in the estimation result management unit 318. The process executed by the printer 102 in the recommended action estimation process is implemented by the CPU 231 of the printer 102 reading the program and resource data stored in the memory (the ROM 232, the external memory 236, or the like) and executing the program. The process executed by the repair part notification server 101 in the action estimation process is implemented by the CPU 201 of the repair part notification server 101 reading the program and resource data stored in the memory (the ROM 202, the HDD 204, or the like) and executing the program.

In S401, the control unit 323 of the printer 102 detects whether or not an error has occurred in the printer 102. When the control unit 323 detects the occurrence of the error, the processing of S402 is performed. On the other hand, when the occurrence of the error has not been detected, the control unit 323 iterates the processing of S401. In S402, the operation information transmission unit 321 of the printer 102 transmits operation information including error information corresponding to the error detected by the control unit 323 to the repair part notification server 101. Hereinafter, the operation information including the error information is also simply referred to as error information. The error information transmitted by the operation information transmission unit 321 includes, for example, an error ID for uniquely identifying an error, a device ID and a model number that are device information, an error code indicating an error, a counter value that is the number of printed pages at the time of the occurrence of the error, and an error occurrence date and time. That is, the operation information transmission unit 321 of the printer 102 transmits the information managed by the error history management unit 313 of the repair part notification server 101 as an error history to the repair part notification server 101. Although an example in which the counter value is included in the error information will be described in the present embodiment, for example, the counter value may be transmitted to the repair part notification server 101 as counter information, which is information separate from the error information. When the counter information is transmitted separately from the error information, the repair part notification server 101 associates the error information with the counter information.

Using the reception of error information from the printer 102 as a trigger, a process of a service provided by the repair part notification server 101 (a repair part notification service) starts. In S403, the operation information reception unit 311 of the repair part notification server 101 receives error information from the printer 102. In S404, the error determination unit 312 registers the error information received from the printer 102 in the error history management unit 313 as an error history.

In S405, the error determination unit 312 acquires an error history received in the past from the printer 102 serving as a transmission source of the error information received in S403 from the error history managed by the error history management unit 313. Specifically, the error determination unit 312 acquires an error history consistent with the device ID included in the error information received from the printer 102 from the error history managed by the error history management unit 313. For example, when the device ID included in the error information is “DEV0000001,” the error determination unit 312 acquires the records in the first and third rows of Table 2.

In S406, the error determination unit 312 outputs a list of part numbers of repair parts for an action to be performed to eliminate an error according to a rule base and its failure possibility using the error information received from the printer 102 and the error history acquired from the error history management unit 313. A list of part numbers of repair parts for the action to be performed and their failure possibilities is a list shown in Table 1.

In S407, the priority determination unit 314 acquires a market record (a market replacement record and a market action record) consistent with a model number and an error code of error information from the market record management unit 315. For example, it assumed that the model number included in the error information is “Model-001” and the error code is “E001-0001.” In this case, the priority determination unit 314 acquires records of the first to sixth rows of Table 3 as market replacement records and records of all rows in Table 6 as market action records.

In S408, the priority determination unit 314 confirms a repair part determination result (Table 1) output by the error determination unit 312 and determines whether or not there is a part determined to have a high failure possibility. Specifically, the priority determination unit 314 performs the processing of step S409 by determining that there is a part determined to have a high failure possibility when a repair part failure possibility is a high failure possibility in the determination result (Table 1) in which the part number and the failure possibility output in S406 are listed. For example, the priority determination unit 314 performs the processing of S409 when a high possibility and a low possibility are mixed for each part. On the other hand, when possibilities of failures of all repair parts are low, the priority determination unit 314 determines that there are no parts determined to have a high failure possibility and performs the processing of S410. In addition, the processing of S410 will be described in Example 2.

In S409, the priority determination unit 314 ranks estimated repair parts and sets priorities thereof. Specifically, the priority determination unit 314 first acquires a part number included in the failure possibility list (Table 1) output in S406 and the number of replacements of a part consistent with the part number from the market records acquired in S407. Subsequently, the priority determination unit 314 calculates a failure cause probability for each part number and associates the calculated failure cause probability with the part number. The failure cause probability is calculated as, for example, “(number of repair part replacements/total number of replacements of all parts replaced for error)×100.” That is, the priority determination unit 314 calculates failure cause probabilities in units of parts so that a sum of failure cause probabilities of all parts that have been replaced is 100% for an error code of an error that has occurred in a certain model.

For example, it is assumed that the part numbers of the estimated repair parts are [Part1-111, Part2-222, Part3-333, Part4-444, Part5-555] and the market records obtained in S407 are the first to fifth rows of Table 3. In this case, the total number of replacements of all parts replaced in the market records of the first to fifth rows is 1000. The failure cause probability of the part number “Part 1-111” is “(510/1000)×100=51.0.” Likewise, the failure cause probabilities of the other part numbers “Part2-222,” “Part3-333,” “Part4-444,” and “Part5-555” are “21.8,” “9.2,” “4.0,” and “14.0,” respectively. Also, the priority determination unit 314 sets the calculated failure cause probability as a priority. Although the failure cause probability is calculated as a ratio of the number of action records of the repair parts to the total number of replacements of the total repair parts for the action to be performed in the present embodiment, the method for calculating the failure cause probability is not limited thereto and another method may be used.

Next, the priority determination unit 314 ranks priorities. At this time, the priority determination unit 314 refers not only to the calculated failure cause probabilities, but also to the part number of the repair part for an action to be performed output by the error determination unit 312 in S406 and a list of failure possibilities thereof (Table 1). Therefore, the priority determination unit 314 ranks the priorities on the basis of high and low failure possibilities of parts on the basis of the calculated failure cause probabilities and the list of failure possibilities output by the error determination unit 312 in S406.

For example, the failure cause probability of “Part1-111” is “(510/1000)×100=51.0.” Likewise, the failure cause probabilities of the other part numbers “Part2-222,” “Part3-333,” “Part4-444,” and “Part5-555” are “21.8,” “9.2,” “4.0,” and “14.0,” respectively. Moreover, the priority determination unit 314 sorts repair parts with the “high possibility” and repair parts with the “low possibility” on the basis of the failure possibilities of the part numbers in descending order of the failure cause probability. In Table 1, the failure possibilities of the part numbers “Part2-222,” “Part3-333,” “Part4-444,” and “Part5-555” are “high possibility,” “high possibility,” “high possibility,” “low possibility,” and “low possibility,” respectively. The failure cause probabilities of the repair parts “Part1-111,” “Part2-222,” and “Part3-333” with the “high possibility” are “51.0,” “21.8,” and “9.2,” respectively. Therefore, the priorities are in the order of “Part1-111,” “Part2-222,” and “Part3-333.” Likewise, the failure cause probabilities of the repair parts “Part4-444” and “Part5-555” with the “low possibility” is “4.0” and “14.0,” respectively, and their priorities are in the order of “Part5-555” and “Part4-444.” Also, when these are combined and arranged in descending order of the failure possibility, the priorities are “1” to “5” in the order of “Part1-111,” “Part2-222,” “Part3-333,” “Part5-555,” “Part4-444.” Furthermore, priorities in results of estimating the repair parts of “Part4-444” and “Part5-555” with a low failure possibility estimated by the priority determination unit 314 are marked by (“-”) indicating that no priority is assigned as shown in Table 4.

In S411 and S412, the aggregation filter unit 316 filters actions that cannot exist for the parts with respect to combinations of repair parts and actions identified in the repair part estimation process. In S411, the aggregation filter unit 316 verifies combinations of repair parts and actions identified in the repair part estimation process in accordance with the definition of the correct answer master management unit 317 and confirms combinations of repair parts and actions that are theoretically incorrect. For example, depending on the part, any of the actions of “replace,” “clean,” and “adjust” may not exist and the action that cannot exist is a theoretically incorrect action. The correct answer master defines a theoretically correct action. The aggregation filter unit 316 determines that combinations that do not exist in the definition of the correct answer master management unit 317 are theoretically incorrect repair parts. When the combination is a combination of a repair part and an action that is theoretically incorrect, the processing of S412 is performed. On the other hand, the aggregation filter unit 316 determines that the combination present in the definition of the correct answer master management unit 317 is a theoretically correct repair part. When the combination is a combination of a repair part and an action that is theoretically correct, the processing of S413 is performed.

In S412, the aggregation filter unit 316 deletes theoretically incorrect combinations of repair parts and actions. The aggregation filter unit 316 indicates the priority of the action determined to be absent by “-” (none). The repair parts determined to have a low possibility by the error determination unit 312 are also marked by “-” in all actions. Even if there is an action for the repair part, it is marked by “-,” but it is distinguished from the case where there is no action for the repair part in the method shown in the description of the UI display to be described below.

In S413, the priority determination unit 314 confirms that the verification of all combinations of repair parts and actions (S411) has been completed. When the verification of all combinations of repair parts and actions has not been completed, the process returns to the processing of S411. On the other hand, when the verification of all combinations of repair parts and actions has been completed, the processing of S414 is performed. In S414, the priority determination unit 314 acquires each action score based on feedback information from the feedback management unit 320, recalculates and adjusts the action priority according to the action score. A method for adjusting the action priority will be described below.

In S415, the priority determination unit 314 registers each calculated action priority in the estimation result management unit 318 as an estimation result together with a device ID and an error code of the error information. For example, Table 7 is an example of results of estimating recommended actions calculated from the examples in Tables 4 and 6. As described above, the repair part notification server 101 can estimate a recommended action for the error that has occurred in the printer 102. If the repair procedure display unit 319 receives a request for displaying the estimated action to eliminate the error from the browser 331 of the PC 103, a repair procedure display screen is displayed on the basis of the estimation results (Table 7) registered in the estimation result management unit 318.

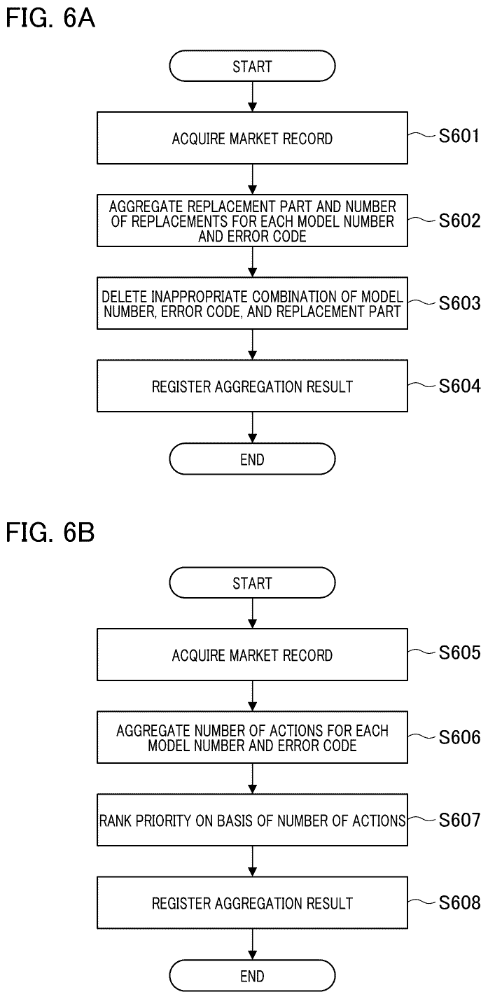

FIGS. 6A and 6B are flowcharts showing a process executed by the priority determination unit 314 in steps S407 to S413 of the recommended action estimation process. Each process executed by the priority determination unit 314 is implemented by the CPU 201 of the repair part notification server 101 reading the program and resource data stored in the memory (the ROM 202, the HDD 204, or the like) and executing the program.

FIG. 6A is a flowchart showing a repair part estimation process executed by the priority determination unit 314. According to the repair part estimation process, the priority determination unit 314 finally calculates repair part estimation results (Table 4). In S601, the priority determination unit 314 acquires a market replacement record (Table 3) consistent with the repair part and the part number included in the determination result of the error determination unit 312 from the market replacement record (Table 3), which is an aggregation of the number of replacement parts in the market record managed by the market record management unit 315. The market replacement record acquired here includes information about model numbers, error codes, and replacement parts. In S602, the priority determination unit 314 aggregates replacement parts and the number of replacements for each combination of the model number and the error code. In the aggregation, the priorities of repair parts are also ranked.

In S603, the priority determination unit 314 deletes an incorrect combination from the combinations of the model numbers, error codes, and replacement parts. The priority determination unit 314 deletes the incorrect combination by causing the aggregation filter unit 316 to perform a filtering process using a correct answer master that defines a theoretically correct process for the failure managed by the correct answer master management unit 317. In S604, the priority determination unit 314 registers repair part estimation results calculated up to S603 in the priority determination unit 314. According to the repair part estimation process shown in FIG. 6A, the priority determination unit 314 calculates the repair part estimation results shown in Table 4.

FIG. 6B is a flowchart showing an action estimation process executed by the priority determination unit 314. According to the action estimation process, the priority determination unit 314 finally calculates action estimation results (Table 6). In S605, the priority determination unit 314 acquires a market replacement record consistent with the repair part and the part number included in the determination result of the error determination unit 312 from the market action record (Table 5), which is an aggregation of actions of the market record managed by the market record management unit 315. The market action records obtained here include information about model numbers, error codes, and actions that have been performed. In S606, the priority determination unit 314 aggregates the number of actions and processes performed for each combination of the model number and the error code.

In S607, the priority determination unit 314 decides the priority of each action from the action records in the market aggregated in S606. Here, the actions that can be acquired as market records are classified into three types, for example, “replace,” “adjust,” and “clean” for the aggregation. The number of actions for each model number and error code is calculated and the ratio of each action is obtained as a percentage. The priority of the action with the highest ratio that has been obtained is denoted by “A.” Furthermore, it is assumed that the action with the highest ratio is used as a standard, the priority is set to “A” when the difference from the action is less than or equal to 5%, the priority is set to “B” when the difference is greater than 5% and equal to or less than 20%, and the priority is set to “C” when the difference is greater than 20%. For example, when the ratio of “replace” is 50%, the ratio of “clean” is 35%, and the ratio of “adjust” is 15%, “replace” has the priority “A,” “clean” has the priority “B,” and “adjust” has priority “C.” Table 6 shows a recommended action estimation result for an error with the model number of Model-001 and the error code of E001-001 in the examples in Table 5. In S608, the priority determination unit 314 registers action estimation results aggregated up to S607 in the priority determination unit 314. In addition, together with the priorities indicated by “A,” “B,” and “C,” the ratio of the number of actions for each action may be included in the estimation result. According to the action estimation process shown in FIG. 6B, the priority determination unit 314 calculates the action estimation result shown in Table 6.

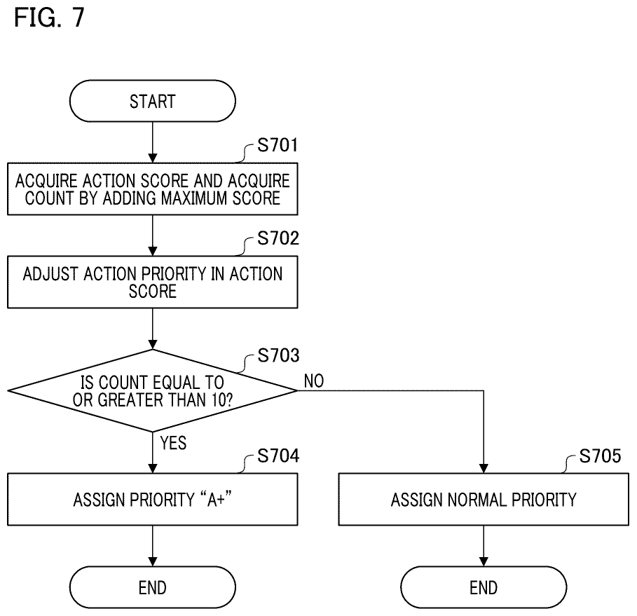

Details of the action priority adjustment process of S414 will be described with reference to FIG. 7. FIG. 7 is a flowchart showing an action priority adjustment process executed by the priority determination unit 314. The present process is performed after the priority determination unit 314 confirms that verification of all combinations of repair parts and actions is completed in S415 and before the estimation result is registered in the estimation result management unit 318 in S415. According to the action priority adjustment process shown in FIG. 7, the priority determination unit 314 calculates the estimation results (Table 7) registered in the estimation result management unit 318. Each process executed by the priority determination unit 314 is implemented by the CPU 201 of the repair part notification server 101 reading the program and resource data stored in the memory (the ROM 202, the HDD 204, or the like) and executing the program.

In S701, the priority determination unit 314 adjusts a priority of the action estimated in the action estimation process on the basis of feedback information. First, the priority determination unit 314 acquires a ratio of the number of actions based on the market record of the recommended actions estimated on the basis of the market record as an action score. The ratio serving as this action score is the ratio used when the priority is set in S607. The action score is a value assigned to each of “replace,” “adjust,” and “clean,” and an initial value for each error code is calculated from the ratio of an action in the market record. For example, when the ratio of “replace” is 50%, the ratio of “clean” is 35%, and the ratio of “adjust” is 15%, the initial score of “replace” is 50, the initial score of “clean” is 35, and the initial score of “adjust” is 15. Here, the priority determination unit 314 reflects the content of the feedback information held in the feedback management unit 320 and the action score fluctuates. In this case, the priority determination unit 314 performs a filtering process so that feedback information associated with an error history to which a “batch action flag” is assigned is not reflected. The “batch action flag” will be described in an item of a handling state change process of error information to be described below. On the basis of the feedback information, the priority determination unit 314 sets a score of +2 for the action that has been actually performed and adds-1 for other actions. For example, when there are two feedback information items indicating that the action of “replace” has been executed for the above initial score, the score of “replace” is updated to 54 by adding +2 for two cases, the score of “clean” is updated to 33 by adding −1 for two cases, and the score of “adjust” is updated to 13 by adding −1 for two cases. Moreover, when the action score is added, the number of times a score is added to the action already having a highest action score is further counted continuously. For example, when the score of “replace” is the highest, the count is added by +1 when one feedback case for which a replace action has been performed is acquired and the count is added by −1 when feedback for which another action has been performed is acquired. The count is not less than 0. The sequential order in which the feedback is processed is, for example, the sequential order in which the feedback has been received.

In S702, the priority determination unit 314 updates the action priority on the basis of the action score acquired in S701. In accordance with a method of a market record aggregation process described in S607, the priority of each action is obtained again with the action score as a ratio of each action. In S703, the priority determination unit 314 confirms how many times an increased score has been received in that state for the action having the highest action score. When the count calculated together with the action score is acquired in S701 and the count value is 10 or more, the priority determination unit 314 performs the processing of S704. On the other hand, when the count value is 9 or less, the priority determination unit 314 performs the processing of S705.

In S704, the priority determination unit 314 ends by assigning a special priority “A+” to the action having the highest action priority “A.” In S705, the priority determination unit 314 ends as it is. That is, the priority “A” is given to the action having the highest action priority “A” as it is. After S704 or S705 is completed, the priority determination unit 314 registers a priority of an estimated recommended action for which the adjustment has been completed in the estimation result management unit 318. According to the action priority adjustment process shown in FIG. 7, the priority determination unit 314 calculates an estimation result registered in the estimation result management unit 318 shown in FIG. 7.

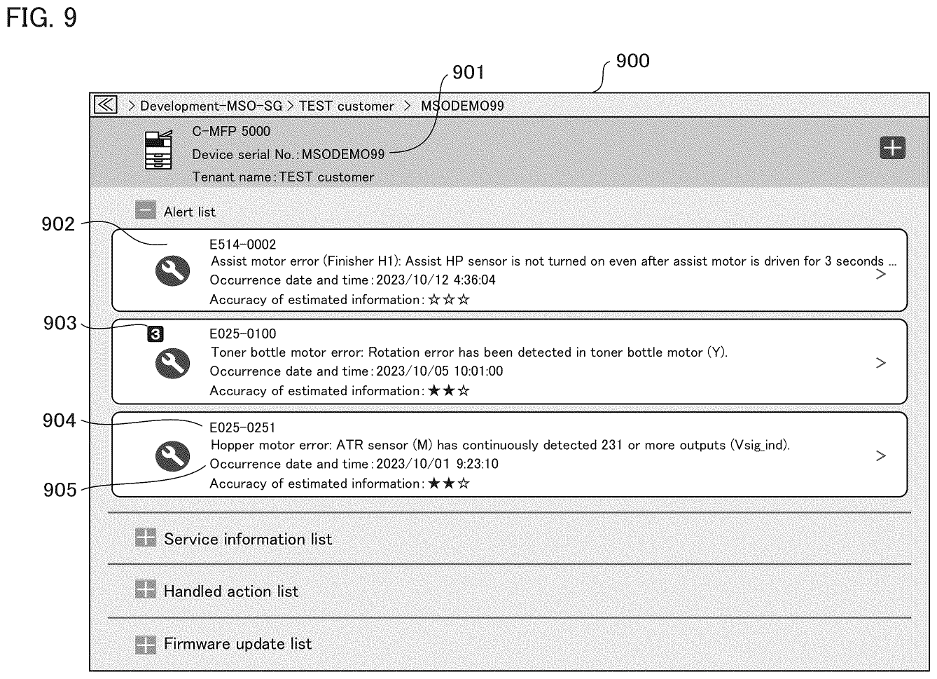

When an error information acquisition request including a device ID is received from the browser 331 of the PC 103, the repair procedure display unit 319 generates an error information list screen (FIG. 9) on the basis of an error history managed by the error history management unit 313 and provides the generated error information list screen to the PC 103. In an alert list on the error information list screen, error information for which the handling state status (handling information) is “unhandled” is listed and displayed in the error history (Table 2).

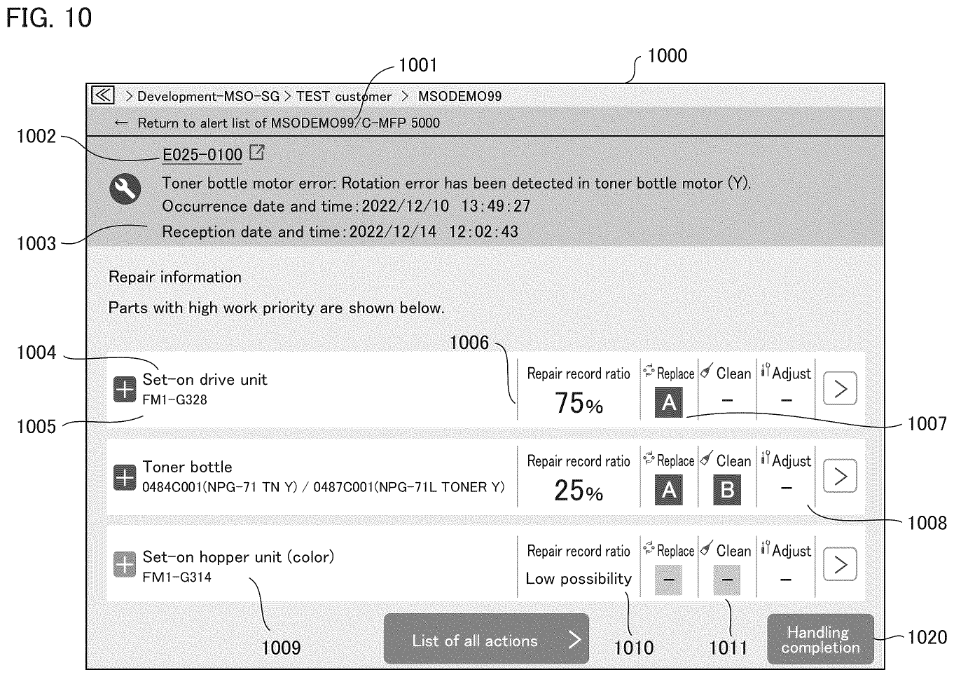

When the error information is selected in the alert list on the error information list screen, the repair procedure display unit 319 of the repair part notification server 101 displays a repair procedure display screen (FIG. 10) indicating a repair procedure for the selected error. The customer engineer performs a high-priority process with reference to the repair procedure display screen. When the error is eliminated by the action that has been performed, the customer engineer inputs feedback information to a feedback information input screen (not shown) provided to the browser 331 of the PC 103 and transmits the input feedback information to the repair part notification server 101. The feedback information transmitted from the PC 103 to the repair part notification server 101 includes device information including a device ID for which the action has been performed, error information such as an error code, an error occurrence date and time, and information about a process in which the error has been eliminated. In the repair part notification server 101 that has received the feedback information, the feedback information is managed by the feedback management unit 320. Furthermore, the repair part notification server 101 performs a process of changing the handling state of the error history managed by the error history management unit 313 on the basis of the feedback information. Because the repair part notification server 101 of the present example allows multiplex transmission of errors as a measure to prevent the omission of error transmission due to a device restart when an error occurs or the omission of reception such as data loss due to the user's infrastructure environment, error information having the same error code may be duplicated. Even if the error information is duplicated, only a single action is performed for the error of the duplicate error information. Therefore, when an action is performed for one of the duplicate error information items and a report indicating that the action is completed is received, it is desirable to consider the action as completed when addressing the other duplicate error information.

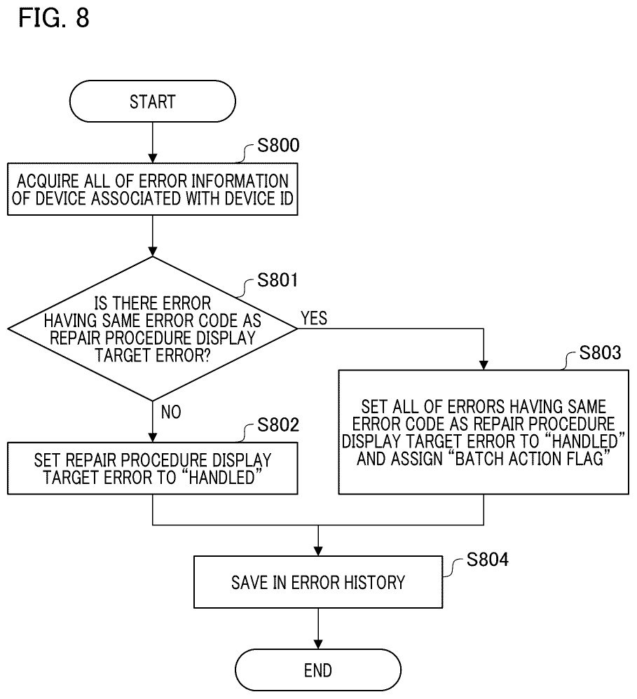

FIG. 8 is a flowchart showing a process for changing the handling state of the error history. Each of the processes shown in FIG. 8 is implemented by the CPU 201 of the repair part notification server 101 reading the program and resource data stored in the memory (the ROM 202, the HDD 204, or the like) and executing the program. The process for changing the handling state of the error history is started by receiving the content of the action performed to eliminate the error from the PC 103 as feedback on an estimation result calculated by the repair part notification server 101.

In S800, the error history management unit 313 acquires error information from the error history on the basis of the feedback information received from the browser 331 of the PC 103. The error history management unit 313 acquires all of error information in which the handling state status associated with the device ID included in the feedback information is “unhandled” from the error history. That is, the error history management unit 313 acquires not only a repair procedure display target error of an action target displayed on the repair procedure display screen but also all of error information for which the handling state status is “unhandled” for the printer 102.

In S801, the error history management unit 313 searches for error information having an error code identical to the error code included in the feedback information from the error information acquired in S800 and confirms whether there is error information with the same error code. That is, the error history management unit 313 confirms whether there is other error information having the same error code as the repair procedure display target error of the action target displayed on the repair procedure display screen. When there is error information having the same error code as the repair procedure display target error, the processing of S803 is performed. On the other hand, when there is no error information having the same error code as the repair procedure display target error, the processing of S802 is performed.

In S802, the error history management unit 313 changes the handling state status of the error information of the repair procedure display target error to “handled.” That is, the error history management unit 313 updates the handling state status of the error information for which feedback related to the action (maintenance handling) input by the customer engineer who has performed an action for eliminating the error has been received from “unhandled” to “handled.”

In S803, the error history management unit 313 changes all the handling state statuses of the repair procedure display target error and all errors having the same error code as the repair procedure display target error to “handled.” That is, the error history management unit 313 updates the handling state status of the error for which feedback related to maintenance handling has been received to “handled” and collectively updates the handling state statuses of errors having the same error code as the error from “unhandled” to “handled.” At the same time, the error history management unit 313 assigns a “batch action flag” to the error information of all errors other than the repair procedure display target error among the errors for which the handling state statuses have been changed collectively. In addition, the repair procedure display target error is the most recent error with the same error code. Therefore, the “batch action flag” is assigned to the error information of all errors other than an error having the most recent occurrence date and time among the errors for which the handling state statuses have been changed collectively. The “batch action flag” indicates that the error information has been changed in its handling state status together with the error for which feedback has been received. That is, the error history management unit 313 assigns the batch action flag” to error information having the same error code as the error for which the feedback related to maintenance handling has been received and having the handling state statuses collectively updated to “handled.”

In the present example, when the records of maintenance handling are aggregated, the error information to which the “batch action flag” is assigned is not included in the aggregation. Thereby, even if the error information having the same error code is duplicated due to multiplex transmission of errors from the printer 102 or the like, they can be aggregated as a single error. For example, in the process of storing feedback information in the feedback management unit 320, a process of associating feedback information with all error information in which the handling state status has been changed to “handled” is performed. Also, when the feedback information is aggregated and the action score is calculated, the feedback management unit 320 performs a filtering process so that the feedback information of the error history to which the “batch action flag” is assigned is not aggregated. By excluding the feedback information of the error history to which the “batch action flag” is assigned when the action score is calculated, the accuracy of the action score used in the action priority adjustment process can be improved. If a plurality of feedback items for duplicate errors are saved for single repair handling of the user, there is a deviation between the number of dispatches and the number of feedback items, but the deviation between the number of dispatches and the number of feedback items can be suppressed by setting the “batch action flag,”

In S804, the error history management unit 313 saves the error information obtained by changing the handling state status to “handled” in the error history managed by the error history management unit 313. In this way, it is possible to collectively change the handling state statuses of the repair procedure display target error managed as the error history and the error having the same error code as the repair procedure display target error to “handled.” Moreover, the repair procedure display unit 319 reflects the change from “unhandled” to “handled,” updates the display of the alarm list indicating the error information of “unhandled” displayed on the error information list screen, and excludes the error information changed to “handled” from the alarm list.

Because the repair part notification server 101 allows multiplex transmission of errors as a measure to prevent the omission of error transmission due to a device restart when an error occurs or the omission of reception such as data loss due to the user's infrastructure environment, error information having the same error code may be duplicated. Even if the error information having the same error code is acquired from the printer 102 repeatedly according to the handling status change process shown in FIG. 8, when the action is completed for one error, errors having the same error code can also be processed as if actions for the errors are completed. For duplicate errors, by collectively setting that the actions for the errors have been handled, an error occurring in an aggregation of error histories or the like can be suppressed and the estimation of the faulty part and the accuracy of the estimation of the action can be improved. Moreover, by collectively setting that actions for the errors have been handled, the customer engineer does not need to individually report that the handling of the error has been completed for each error and the time and effort of the customer engineer can be saved.

Although an example in which the handling state statuses of errors having the same error code as the error for which feedback has been received are automatically updating to “handled” has been described in the present example, the user may be able to select whether or not to collectively update the error information having the same error code. For example, the selection of whether or not to collectively perform an update process is received by providing a check box for allowing the customer engineer who has performed the action to select whether or not to “collectively set actions for other alerts as completed” on a screen where the customer engineer who has performed the action inputs the feedback information.

FIG. 9 is a diagram showing an example of an error information list screen. The error information list screen 900 is provided by the repair procedure display unit 319 of the repair part notification server 101 that has received an error information acquisition request including a device ID from the browser 331 of the PC 103, and is displayed on the browser 331 of the PC 103. The error information list screen 900 displays error information of a device managed by the repair part notification server 101.

The error information list screen 900 includes device information including the device ID 901 and an alert list. A device ID designated in the error information acquisition request is displayed in the device ID 901. Furthermore, the error information list screen 900 may include information about the customer installing the device, a service information list, a handled action list, and a firmware update list. In the service information list, precautions for the user (in this case, the user in charge of repairs) for the device or the like are displayed. A handling completion list displays a list of alerts (errors) for which repair handling has been completed on the device. In the firmware update list, the update history of the software (firmware) installed within the device is displayed in a list.

In the alert list, error information 902 occurring in a designated device is listed and displayed. The error information 902 includes an error code 904 and an occurrence date and time 905. Moreover, when there are duplicate errors, the duplicate error count 903 is displayed in the error information 902. Moreover, the accuracy of estimation of the error information may be displayed in the error information 902.

The error information 902 is error information of an error occurring in the device associated with the device ID designated in the error information acquisition request. The error information acquired here includes at least an error code, an occurrence date and time, and a handling state status. The repair procedure display unit 319 displays only errors whose handling state statuses are “unhandled” in the error history managed by the error history management unit 313 in the alert list. When there are a plurality of error information items, for example, the plurality of error information items are displayed in the sequential order from the most recent occurrence date and time.

When a plurality of errors having the same error code are included in the error information, the repair procedure display unit 319 displays the number of times an error occurs repeatedly as the duplicate error count 903 after a single error information item 902 is displayed in a state in which the errors are aggregated. In an error code 904, the error code for each error is displayed. In the occurrence date and time 905, the occurrence date and time of each error is displayed. In the case of duplicate errors as errors having the same error code displayed together, the occurrence date and time of the most recent error is displayed among the duplicate errors.

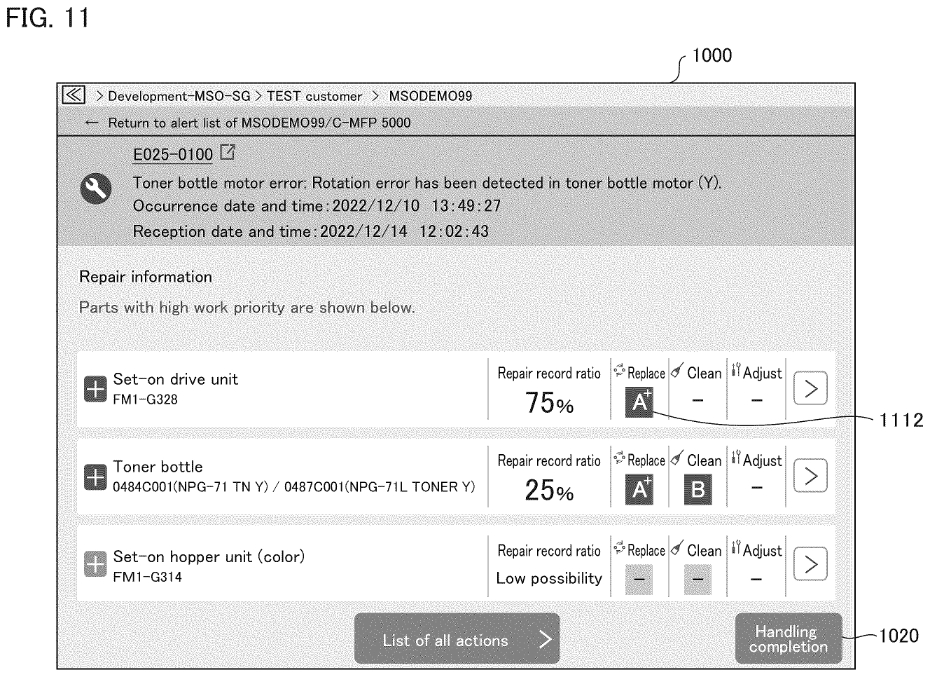

FIGS. 10 and 11 are diagrams showing an example of a repair procedure display screen. The repair procedure display screen 1000 is provided by the repair procedure display unit 319 of the repair part notification server 101 that has received a repair procedure acquisition request including a device ID and an error code from the browser 331 of the PC 103, and is displayed in the browser 331. The information provision system is a system that displays a repair procedure for eliminating the error in units of errors that have occurred and the repair procedure display screen 1000 includes a repair procedure for the error designated from the browser 331. For example, when the error information 902 is selected by a customer engineer in the alert list of the error information list screen 900 (FIG. 9), the browser 331 transmits a repair procedure acquisition request including an error code and a device ID corresponding to the selected error information 902. Also, as a response to the repair procedure acquisition request, the browser 331 displays a repair procedure display screen provided by the repair part notification server 101.

FIG. 10 is an example of a repair procedure display screen when there is no action to which the action priority “A+” is assigned. FIG. 11 is an example of a repair procedure display screen when there is an action to which the action priority “A+” is assigned. The repair procedure display screen 1000 displays an error history and an estimation result managed by the repair part notification server 101. The repair procedure display screen 1000 includes a device ID 1001, an error code 1002, an occurrence date and time 1003, a repair part 1004, a part number 1005, a failure cause probability 1006, a recommended action 1007, a part number 1009, and a handling completion button 1020.

In the device ID 1001, a device ID of an error history consistent with an error ID designated in the repair procedure acquisition request and an error code within the error history managed by the error history management unit 313 is displayed. In the error code 1002, an error code of the error history consistent with the error ID designated in the repair procedure acquisition request and the error code within the error history managed by the error history management unit 313 is displayed.

In the occurrence date and time 1003, the occurrence date and time of an error history consistent with the error code designated in the repair procedure acquisition request and an error code within the error history managed by the error history management unit 313 is displayed. In the repair part 1004, an estimation result in which the error ID of the repair procedure acquisition request is located among the estimation results managed by the estimation result management unit 318 is displayed. The repair procedure display unit 319 sets a sequential order of the estimation results that are displayed in the repair part 1004 in descending order of priorities of replacement part estimation results, such that it is possible to present a part from which a repair process begins to the customer engineer. Although only the estimation results are displayed in order of priority in the present example, the fact that it is “a part for which an action is to be performed” may be additionally displayed on the repair procedure display screen 1000 with an icon or message,” for example, with respect to an estimation result with priority exceeding a threshold value when there are a plurality of estimation results. In the part number 1005, the part number of the repair part 1004 is displayed. In addition, in the case of a part determined to have a low failure possibility by the error determination unit 312, it may be displayed at a low level in accordance with the priority managed by the estimation result management unit 318, and the display itself may be grayed out.

In the failure cause probability 1006, a failure cause probability of a repair part managed by the estimation result management unit 318 is displayed and a ratio of the market record of a relevant part among parts that have been replaced due to the same error that occurs in the same model is indicated. Furthermore, in the case of a part determined to have a low failure possibility by the error determination unit 312, a “low possibility” may be displayed instead of a numerical value indicating the ratio in the failure cause probability 1006.

In the recommended action 1007, the priority of the recommended action is displayed. In the recommended action 1007, the priorities of “replace,” “clean,” and “adjust” are marked by “A+,” “A,” “B,” “C,” and “-” on the basis of the recommended action estimation result managed by the estimation result management unit 318. In the recommended action 1007, it is indicated that the replacement priority is “A.” The mark “-” shown in the recommended action 1008 indicates that there is no particular action according to a part. A recommended action 1112 is an example where there is an action to which the action priority “A+” is assigned as a result of performing an action priority adjustment process (FIG. 7) based on feedback.

The handling completion button 1020 is a button selected by the customer engineer when the action (maintenance handling) for eliminating the error is completed. The repair procedure display unit 319 of the repair part notification server 101 that detects the selection of the handling completion button 1020 provides a feedback information input screen to the browser 331 of the PC 103. The customer engineer inputs feedback information according to the display of the feedback information input screen, and transmits the feedback information to the repair procedure display unit 319 of the repair part notification server 101. The feedback information transmitted from the PC 103 to the repair part notification server 101 includes device information about the device for which maintenance handling has been performed and error information including an error code corresponding to the eliminated error. Moreover, the feedback information transmitted from the PC 103 to the repair part notification server 101 includes content of the action performed by the customer engineer to eliminate the error (maintenance handling content). In addition, information indicating how many errors having the same error code as the error being displayed have occurred is displayed on the feedback information input screen. That is, when the duplicate error count 903 is displayed in the alert list, explanatory content of the duplicate error count 903 is displayed on the feedback information input screen.

The part number 1009, the failure cause probability 1010, and the recommended action 1011 are related to an example of a part determined to have a low possibility in the error determination unit 312. In this case, it is displayed at a low level in accordance with the priority managed by the estimation result management unit 318. Moreover, the display of the part determined to have the low possibility may be distinguished at a glance from the display of a part determined to have a high possibility, for example, according to the gray-out display or the like. Furthermore, the action for the part determined to have the low possibility is also marked by “-” as shown in the recommended action 1011, but a background color is added and distinguished from “-” of the case where there is no process (no theoretically correct action). Thus, in the repair procedure display screen 1000, repair parts for eliminating an error that has occurred in the printer 102 are ranked in order from a highest possibility that the error will be eliminated, and recommended actions are also displayed.

As described above, according to the present example, even if error information having the same error code is repeatedly acquired from the printer 102, when the action is completed for one error, errors having the same error code can also be processed as if the actions for the errors have been completed. By collectively setting that the actions for the errors have been handled, an error occurring in an aggregation of error histories or the like can be suppressed and the estimation of the faulty part and the accuracy of the estimation of the action can be resolved. Moreover, by collectively setting that the action for the error has been handled, the customer engineer does not need to individually provide handling completion reports for errors and the time and effort of the customer engineer can be saved. Moreover, duplicate errors are displayed together in the alert list on the error information list screen that becomes a screen that is easy for the customer engineer to see, and it is possible to suppress the omission of an action for an error due to overlooking of the error. Moreover, duplicate errors are displayed together in the alert list on the error information list screen, only a single feedback information input is required on the screen, and the work time required to input feedback information of the customer engineer can be shortened.

### Example 2

In Example 1, in S406, it is assumed that the error determination unit 312 outputs one or more parts having a high failure possibility. That is, in Example 1, the error determination unit 312 outputs one or more parts having a high failure possibility and the processing of S409 is performed after the determination of S408 is made. However, the error determination unit 312 may output only parts with a low failure possibility without outputting parts with a high failure possibility. In this case, the processing of S410 is performed after the determination of S408. According to a method for displaying the repair procedure display screen in Example 1, all parts are grayed out, the failure cause probability is a “low possibility,” any of the action priorities of “A,” “B,” and “C” is not displayed, and sufficient information for the user is not provided. Therefore, in the present example, an example in which appropriate information is displayed on the repair procedure display screen will be described even if the error determination unit 312 outputs only parts with a low failure possibility. In the present example, the description of parts similar to those of Example 1 is omitted.

The software configuration in the present example is similar to the software configuration (FIG. 3) of Example 1. In the present example, the priority determination unit 314 ranks and sets the priorities of the estimated repair parts in S410. Although priorities and failure cause probabilities are processed using a difference of failure possibility levels output by the error determination unit 312 between parts in S409 of Example 1, this is not performed in the present example.

Specifically, the priority determination unit 314 first acquires the number of replacements of a part whose part number is consistent with a part number included in a list (Table 1) of failure possibilities output in S406 from the market record acquired in S407. In the present example, it is assumed that the negotiability of the list of failure possibilities (Table 1) output by the error determination unit 312 is all “low.” Subsequently, the priority determination unit 314 calculates the failure cause probability for each part number and associates it with the part number. The failure cause probability is calculated as, for example, “(number of replacements of repair part/total number of replacements of all parts replaced for error)×100.” That is, the priority determination unit 314 calculates failure cause probabilities in units of parts so that a sum of failure cause probabilities of all parts that have been replaced is 100% for an error code of an error that has occurred in a certain model.

For example, it is assumed that the part numbers of the estimated repair parts are [Part1-111, Part2-222, Part3-333, Part4-444, Part5-555] and the market records obtained in S407 are the first to fifth rows of Table 3. At this time, the total number of replacements of all parts replaced in the market records of the first to fifth rows is 1000. The failure cause probability of the part number “Part1-111” is “(510/1000)×100=51.0.” Likewise, the failure cause probabilities of the other part numbers “Part2-222,” “Part3-333,” “Part4-444,” and “Part5-555” are “21.8,” “9.2,” “4.0,” and “14.0,” respectively. Also, the priority determination unit 314 sets the calculated failure cause probability as a priority.

The priority determination unit 314 ranks the priority. In this case, the priority determination unit 314 ranks the priority on the basis of the calculated failure cause probability. Table 8 is an example of an estimation result managed by the estimation result management unit 318 in the present example. Table 8 of the present example corresponds to Table 7 of Example 1.

TABLE 8

| | | | | Failure cause | | | |
|---|---|---|---|---|---|---|---|
| Priority | Device ID | Error code | Part number | probability | Replace | Clean | Adjust |
| 1 | DEV0000001 | E001-001 | Part1-111 | 51 | A | — | A |
| 2 | DEV0000001 | E001-001 | Part2-222 | 21.8 | A | B | — |
| 3 | DEV0000001 | E001-001 | Part5-555 | 14 | A | B | — |
| 4 | DEV0000001 | E001-001 | Part3-333 | 9.2 | A | B | A |
| 5 | DEV0000001 | E001-001 | Part4-444 | 4 | A | — | — |

The estimation result managed by the estimation result management unit 318 includes a priority of a part, a device ID, an error code, a part number, a failure cause probability, and a priority of each of the replace, clean, and adjust actions. Also, when the repair procedure display screen is displayed on the basis of the estimation result, the repair procedure display unit 319 does not perform a display process for distinguishing the “high possibility” and the “low possibility” of the failure cause probability (e.g., the gray-out display of the “low possibility”) and also does not perform a priority non-display process or the like. The repair procedure display unit 319 displays all repair parts in color on the repair procedure display screen, and also displays the failure cause probability and the priority of the action.

As described above, according to the present example, even if the error determination unit 312 does not output parts with a high failure possibility but outputs only parts with a low failure possibility, it is possible to display appropriate information on the repair procedure display screen and provide sufficient information for the user.

### Example 3

In Example 2, an example in which a display process similar to that of the high possibility is performed when the error determination unit 312 determines that all parts have a low failure possibility has been described. However, when the same display is made for the low possibility and the high possibility, the customer engineer cannot discriminate an estimation accuracy difference. Therefore, in the present example, an icon display process in which the accuracy (reliability) of the estimation can be identified is added to the repair procedure display screen, such that the customer engineer can recognize the accuracy of the information displayed on the repair procedure display screen. In the present example, the description of parts similar to those in Example 1 is omitted.

The repair part notification server 101 of the present example has a reliability determination portion 1201 in addition to the software configuration of the repair part notification server 101 shown in FIG. 3. The reliability determination portion 1201 determines the accuracy (estimation accuracy and reliability) of the estimated information. The reliability is determined on the basis of, for example, the failure possibility of each part in the list of estimated failed parts (Table 1) output by the error determination unit 312 and the market record managed by the market record management unit 315. First, the reliability determination portion 1201 raises or lowers the reliability level by one level according to whether or not the failure possibility of each part in the list of failed parts output by the error determination unit 312 includes a high possibility. For example, the reliability is 3 when the high possibility is included and the reliability is 2 when the high possibility is not included. Subsequently, the reliability determination portion 1201 raises the reliability level by one level or leaves the reliability level as it is on the basis of the state of the market record of the target error managed by the market record management unit 315. For example, when the market record does not reach a parameter that is a reliable value, the reliability is reduced by one level. Table 9 is a table showing an example in which the reliability level determined by the reliability determination portion 1201 is determined. The number of stars indicates reliability and the higher the reliability, the more stars are assigned.

TABLE 9

| | | Market record | |
|---|---|---|---|
| Estimation accuracy | | Less than | Equal to or greater |
| decision matrix | | threshold value | than threshold value |
| Engine | High possibility | ** | *** |
| | is included | | |
| | High possibility | * | ** |
| | is not included | | |

The reliability level is decided according to whether or not the output of the error determination means included in the error determination unit 312 includes a part with a high possibility and whether the parameter of the market record is equal to or greater than the threshold value and the number of icons, for example, *, indicating the reliability increases when the number of available information items increases. When the failure possibilities of parts in the list of failed parts output by the error determination unit 312 include a high possibility and the market record for the target error managed by the market record management unit 315 reaches a parameter that is a reliable value, the reliability is 3. When the failure possibilities of parts in the list of failed parts output by the error determination unit 312 include a high possibility and the market record for the target error managed by the market record management unit 315 does not reach a parameter that is a reliable value, the reliability is 2. When the failure possibilities of parts in the list of failed parts output by the error determination unit 312 do not include a high possibility and the market record for the target error managed by the market record management unit 315 reaches a parameter that is a reliable value, the reliability is 2. When the failure possibilities of parts in the list of failed parts output by the error determination unit 312 do not include a high possibility and the market record for the target error managed by the market record management unit 315 does not reach a parameter that is a reliable value, the reliability is 1.

Although the reliability is determined on the basis of the failure possibility of each part in the list of estimated failed parts (Table 1) output by the error determination unit 312 and the market record managed by the market record management unit 315 in the present example, the reliability determination method is not limited thereto. For example, it may be calculated by numerical values of three levels on the basis of a quantity of a market record. For example, it is assumed that the estimation accuracy is 0 when the total number of replacements is less than 100 in the combination of “model number” and “error code,” the estimation accuracy is 1 when the total number of replacements is equal to or greater than 100 and less than 500, the estimation accuracy is 2 when the total number of replacements is equal to or greater than 500 and less than 1000, and the estimation accuracy is 3 when the total number of replacements is equal to or greater than 100. It is defined that the estimation accuracy increases as the total number of replacements increases and a larger number is assigned. Although an example in which the reliability is displayed in three levels has been shown in the present example, it may be shown in any number of levels.

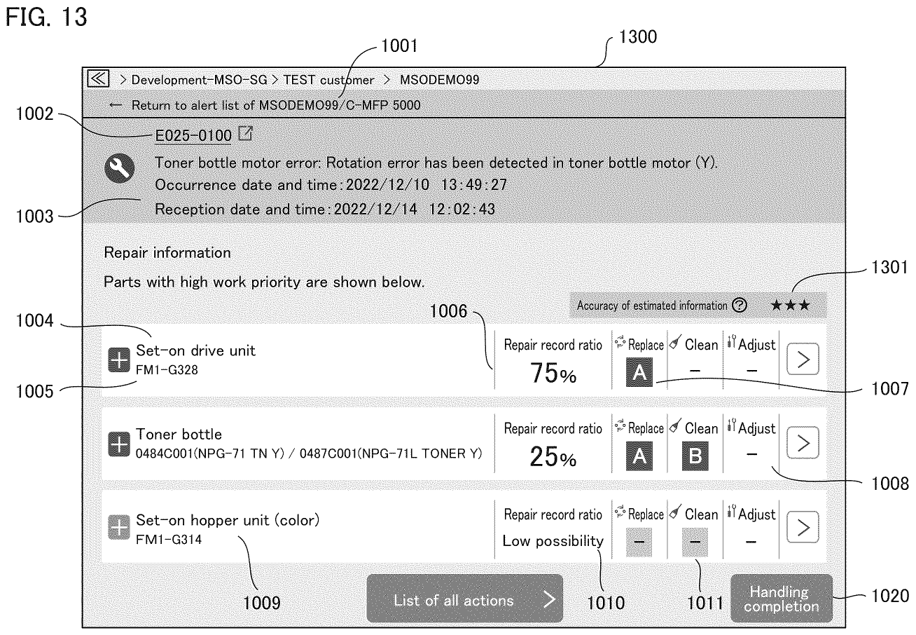

FIG. 13 is a diagram showing an example of the repair procedure display screen in Example 3. The repair procedure display unit 319 of the repair part notification server 101 displays the reliability display portion 1301 on the repair procedure display screen 1300 on the basis of the reliability calculated by the reliability determination portion 1201. The repair procedure display screen 1300 of FIG. 13 is an example of a screen in which the reliability display portion 1301 is added to the repair procedure display screen 1000 of FIG. 10.

According to the present example, the reliability of the estimation result is displayed on the repair procedure display screen and the customer engineer can ascertain the estimated accuracy of the parts and actions displayed on the repair procedure display screen.

### Example 4

In Example 1, an action defined as not existing in the correct answer master that theoretically defines a correct action is marked by “-” Nevertheless, when the customer engineer performs the relevant action marked by “-” and inputs it to the feedback, if an action score for an action that does not actually exist fluctuates and the action priority is adjusted, the definition of the correct answer master becomes weak. Therefore, in the present example, the handling of feedback information when an action defined as not existing in the correct answer master is actually executed will be described. In addition, in the present example, the description of parts similar to those in Example 1 is omitted.

Feedback information for an action defined as not existing in the correct answer master is accumulated in the feedback management unit 320 as in Example 1. Although an action priority adjustment process using feedback information in the priority determination unit 314 is performed in Example 1, the process is not performed in the present example. In the present example, because the action priority adjustment process is not performed in the priority determination unit 314 using feedback information for the action defined as not existing in the correct answer master, the action score of the action defined as not existing in the correct answer master is not changed. Also, the repair procedure display unit 319 of the repair part notification server 101 does not reflect the content of the action score of the action defined as not existing in the correct answer master on the screen provided to the PC 103. On the other hand, the feedback management unit 320 visualizes the accumulation status of feedback information indicating that the action defined as not existing in the correct answer master has been executed and transmits the accumulation status to the correct answer master management unit 317. Thereby, the person in charge of developing and adjusting the correct answer master can utilize the information to reduce the deviation between the user and the correct answer master.

As described above, according to the present example, the feedback information of the action defined as not existing in the correct answer master can be prevented from being reflected in the action priority adjustment process and the display screen. On the other hand, the person in charge of developing and adjusting the correct answer master can be notified of feedback information of the action defined as not existing in the correct answer master.

### (Other Embodiments)

Embodiment(s) of the present invention can also be realized by a computer of a system or device that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or device by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU) or micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-020510, filed Feb. 14, 2024, which is hereby incorporated by reference herein in its entirety.

What is claimed is:

1. An information provision system comprising:
a memory storing instructions; and
a processor executing the instructions causing the information provision system to:
manage error information indicating errors occurring in an image processing device collected from the image processing device;
provide a screen in which information about unhandled errors of the designated image processing device is listed; and
receive feedback related to handling of maintenance performed on the image processing device,
wherein the error information includes device information for identifying an image processing device, an error code corresponding to a failure of the image processing device, a date and time of occurrence of an error, and handling information indicating whether or not the handling of the maintenance has been performed, and
wherein the processor updates handling information for an error handled by the maintenance for which the feedback has been received from an unhandled state to a handled state and collectively updates handling information of error codes identical to an error code of the error from the unhandled state to the handled state with respect to the error information of the same image processing device.

2. The information provision system according to claim 1, wherein the processor displays information about a plurality of errors having the same error code together in the list.

3. The information provision system according to claim 2, wherein, when the information about the plurality of errors having the same error code is displayed together in the list, the processor displays a most recent occurrence date and time among a plurality of occurrence dates and times as occurrence dates and times of errors and displays the number of errors having the same error code.

4. The information provision system according to claim 1,
wherein the processor assigns a batch action flag to the collectively updated error information, and
wherein the error information to which the batch action flag is assigned is prevented from being included in aggregation when the aggregation of handling records of the maintenance is performed.

5. The information provision system according to claim 1, wherein the processor provides a screen for inputting handling content of the maintenance performed on the image processing device as feedback and receives the feedback including the handling content input to the screen, an error code of an error for which handling has been performed, and device information indicating the image processing device on which the handling has been performed.

6. The information provision system according to claim 1,
wherein the process further executes an instruction causing the information provision system to execute an estimation process related to identifying a faulty part causing an error in the image processing device and estimating an action to resolve the error, and
wherein a result of the estimation process corresponding to error information selected in the list is provided.

7. A control method of an information provision system, the control method comprising:
managing error information indicating errors occurring in an image processing device collected from the image processing device;
providing a screen in which information about unhandled errors of the designated image processing device is listed;
receiving feedback related to handling of maintenance performed on the image processing device; and
updating the error information on the basis of the feedback,
wherein the error information includes device information for identifying an image processing device, an error code corresponding to a failure of the image processing device, a date and time of occurrence of an error, and handling information indicating whether or not the handling of the maintenance has been performed, and
wherein handling information for an error handled by the maintenance for which the feedback has been received is updated from an unhandled state to a handled state and handling information of error codes identical to an error code of the error is collectively updated from the unhandled state to the handled state with respect to the error information of the same image processing device.
